(19) United States
(12) Patent Application Publication
(10) Pub. No.: US 2010/0156059 A1
(43) Pub. Date: Jun. 24, 2010

(54) TRANSPORTATION DEVICE

(75) Inventor: Joachim Esser, Kreuzlingen (CH)

Correspondence Address: Brinks Hofer Gilson & Lione/Ann Arbor, 524 South Main Street, Suite 200, Ann Arbor, MI, 48104, US

(73) Assignee: PracTec GmbH, Kreuzlingen (CH)

(21) Appl. No.: 12/644,807

(22) Filed: Dec. 22, 2009

Related U.S. Application Data
(60) Provisional application No. 61/139,959, filed on Dec. 22, 2008.

(51) Int. Cl. B62B 1/12

(52) U.S. Cl. 280/47.2

(57) ABSTRACT

The present disclosure relates to a transporting device for transporting loads by hand with a base frame made of sheet metal or metal tubing in the manner of a hand truck, which has two transport wheels at a lower end opposite a loading shovel and in the center of the lower end, a support wheel in a first end position. The support wheel can be displaced along the longitudinal extension of the base frame into a second end position.

### CROSS-REFERENCE TO RELATED APPLICATIONS

This application claims the benefit of provisional application Ser. No. 61/139,959, filed on Dec. 22, 2008, the contents of which are incorporated herein by reference in their entirety.

### FIELD

The present invention relates to a transporting device for moving loads by hand.

### BACKGROUND

The statements in this section merely provide background information related to the present disclosure and may not constitute prior art.

In the state of the art, there are many known transporting devices which can be used to transport goods or merchandise by hand. However, depending on their intended use, these transporting devices are designed in different ways. Both uniaxial and biaxial transporting devices are in use. A typical example of the uniaxial transporting device is the so-called hand truck, which is particularly suitable for transporting single, large and solid objects.

In the case of biaxial transporting devices, a distinction is made between transport rollers and transport carts. While a transport roller has only one transport plate that is attached to rollers, transport carts also comprise additional retaining walls and/or shelves, which are assembled in completely different ways, depending on the preferred use. With transport carts, a plurality of objects (including many small objects) can be transported at once without difficulty. Unlike the hand truck, a relatively large space is, however, required in which to drive the transport cart. An additional difference between the uniaxial and biaxial transporting devices is that uniaxial transporting devices are preferably pushed (or also drawn), and biaxial transporting devices are essentially drawn. This means that the transporting devices used during work in a warehouse, for example, often have to be changed according to the requirements.

From DE 297 04 996 U1, a transporting device is known that is designed as a hand truck. In order to ensure that the hand truck does not tip backwards in a loaded state, a supporting device is provided that has two lateral sides and a support wheel attached to them. The supporting device can be pivoted over the lateral sides, whereby the lateral sides can be held in a desired supporting position by means of a locking mechanism. This transporting device can be used exclusively as a hand truck.

### SUMMARY

The present disclosure provides and/or further develop a universally usable transporting device with inexpensive means.

Based on the transporting device of the type initially proposed, the present disclosure includes a support wheel that can be slid into a second end position along the longitudinal extension of the base frame. The transporting device thus offers the advantage of the possibility of changing a uniaxial hand truck into a biaxial transport cart, wherein the support wheel forms the second axle. In the first end position of the support wheel, the transporting device is used as a uniaxial hand truck. In this first end position of the support wheel, the support wheel facilitates pulling the hand truck up a flight of steps.

The user of the transporting device, for example a warehouse worker, has, however, the additional advantage of not having to constantly change the transporting device when transporting different objects. In a few seconds, and without any tools, he can transform the transporting device from a uniaxial hand truck into a biaxial transport cart or transport roller, and vice versa. This flexibility enables the warehouse worker to work very efficiently. At the same time, the worker now only needs one inventive transporting means and not—as usually in the past—a hand truck and a transport cart. This saves considerable cost.

Advantageous further developments of the present disclosure are specified in the sub-claims. Additional characteristics that are relevant to the present disclosure are found in the description and in the drawings, wherein the characteristics, both individually and in various combinations, can be a part of the present disclosure, without this being explicitly mentioned.

It is also proposed that the support wheel be displaceable in a region of the base frame that lies opposite to the transport wheels. This increases the stability of the biaxial transport cart, as both axles are arranged on the two ends of the transporting device.

It is particularly advantageous if the support wheel is connected to a drawbar or tow bar, which serves, on the one hand to bring the support wheel from the first position into the second position, and on the other hand, for pulling the transporting device when the transporting device is used as a transport cart. In that way, the transporting device can be drawn simply and comfortably as a biaxial transport cart using the drawbar in the second end position of the support wheel. When the support wheel is in the first end position, and the transporting device is used as a hand truck, the transporting device will be drawn and pushed using separate grab handles.

It is also proposed that in the first end position of the support wheel a grab handle of the drawbar be countersunk in a retaining bracket of the base frame, which is arranged opposite to the transport wheels. This means, on the one hand, that no implements or tools are required for the conversion of the transporting device from a hand truck into a transport cart, and that on the other hand, the grab handle of the drawbar is not in the way when using the transporting device as a hand truck.

It is also advantageous if the support wheel is displaceable in a guide rail arranged in the center of the longitudinal extension of the base frame, and if the first end position and the second end position of the support wheel are designed as end stops in the guide rail. For this purpose, the support wheel comprises a slot nut that slides securely and smoothly in the guide rail. The stops ensure a defined first and second end position of the support wheel on both sides of the guide rail and prevent the support wheel from being pushed unintentionally out of the guide rail. The guide rail is advantageously designed in such a way that the slot nut locks in place in the end positions.

In order to enable maneuverability of the transport cart, it is also proposed that the support wheel be steerable when it is in the second end position. Whereas during uniaxial use of the transporting device, it is steered by turning the separate grab handles when shifting the position of or pressing the hand truck, a steering device is required for a biaxial transport cart, said steering device preferably allowing a turning of the support wheel, which is arranged at the front of the device, in the direction of motion, by using the drawbar. For this purpose, the device has, for example, an axial groove ball bearing between the slot nut and the support wheel. In this way, a center pivot plate is formed, which enables maneuverability of the transporting device.

It is also proposed that an additional foldaway loading support be arranged in the region of the base frame that is arranged opposite the transport wheels. The loading support is folded up during operation of the transporting device as a transport cart and advantageously helps secure objects from falling off during transport. In the region of the transport wheels, i.e. on the opposite side of the transporting device, the loading shovel (for hand truck operation) serves as a support without structural alteration measures.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 a lateral view and a frontal view of a transporting device during operation as a hand truck;

FIG. 2 a lateral view of the transporting device of FIG. 1 with a representation of the structural alteration of the transporting device;

FIG. 3 a lateral view of the transporting device in FIG. 1 during operation as a transport cart;

FIG. 4 a front view of the retaining bracket of a base frame of the transporting device of FIG. 1 with a countersunk drawbar;

FIG. 5 a lateral view of the retaining bracket with the drawbar of FIG. 4;

FIG. 6 a sectional representation of a fastening of a support wheel of the transporting device of FIG. 1;

FIGS. 7 to 13 different views of a second embodiment; and

FIG. 14 an isometric representation of the base body of the second embodiment.

It should be noted that the disclosure is not limited to the embodiments described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

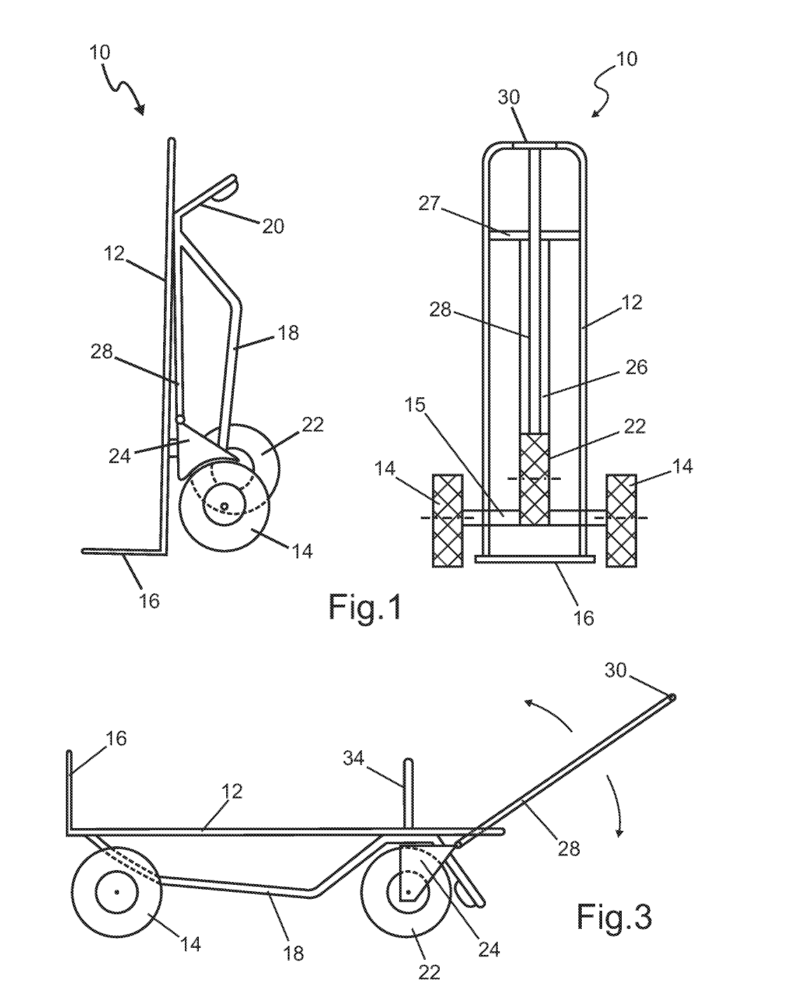

FIG. 1 represents a first exemplary embodiment of an inventive transporting device. It is designated, as a whole, with the reference sign 10. A lateral view of the transporting device 10 is shown on the left side of FIG. 1, and a front view is shown on the right side. The transporting device 10 comprises an essentially rectangular base frame 12, which, like conventional hand trucks, composed of metal tubes. At the lower end of the base frame 12 shown in the lateral view and front view, two transport wheels 14 are rotatably arranged, said transport wheels being connected to one another by an axle 15. The axle 15 is the first axle of the inventive transporting device 10.

A loading shovel 16 is arranged opposite the transport wheels 14 at the lower end of the base frame 12. Together with a side of the base frame 12 pointing toward the loading shovel 16 the loading shovel 16 forms a loading surface of the transporting device 10. Opposite to the loading surface (thus on the side comprising the transport wheels 14), the base frame 12 has a tube-shaped, bent supporting device 18. As an extension of the support device 18, grab handles 20 for operating the transporting device 10 as a hand truck are provided at an end opposite one of the transport wheels 14.

A support wheel 22 is arranged—slightly offset upward—in the center of the base frame 12 between the two transport wheels 14 in the lower region of the transporting device 10. The outer dimensions of the support wheel 22 essentially correspond to the dimensions of one of the transport wheels 14. Two triangular metal plates 24 partially enclose the support wheel 24 on both sides and form a guide for the support wheel 22. The two metal plates 24 are joined in a U-shape (not visible in FIG. 1) and are movably mounted in a guide rail 26 that is designed with a C profile.

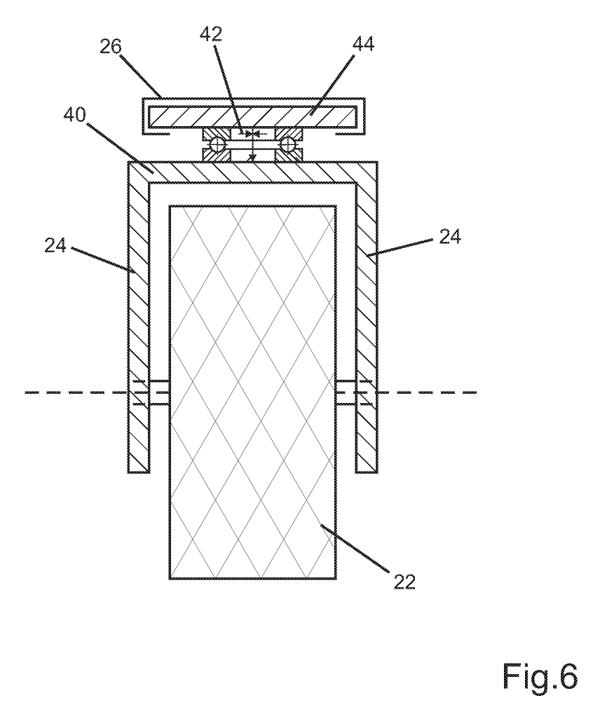

The guide rail 26 is delimited in FIG. 1 on an upper end by a tube-shaped stop 27 that runs vertical to the guide rail 26. The support wheel 22 is rotatably mounted by means of a shaft on an end of the triangular metal plates 24 that protrudes from the base frame 12. At an opposite end of the mounting of the support wheel 22, a tubular drawbar 28 is attached to the metal plates 24 that are connected to one another forming a U-shape, said drawbar being attached in such a way it points essentially parallel to the frame 12 in the direction of the grab handle 20. A detailed description of the design and mode of operation of the support wheel 22 follows below in the description of FIG. 6.

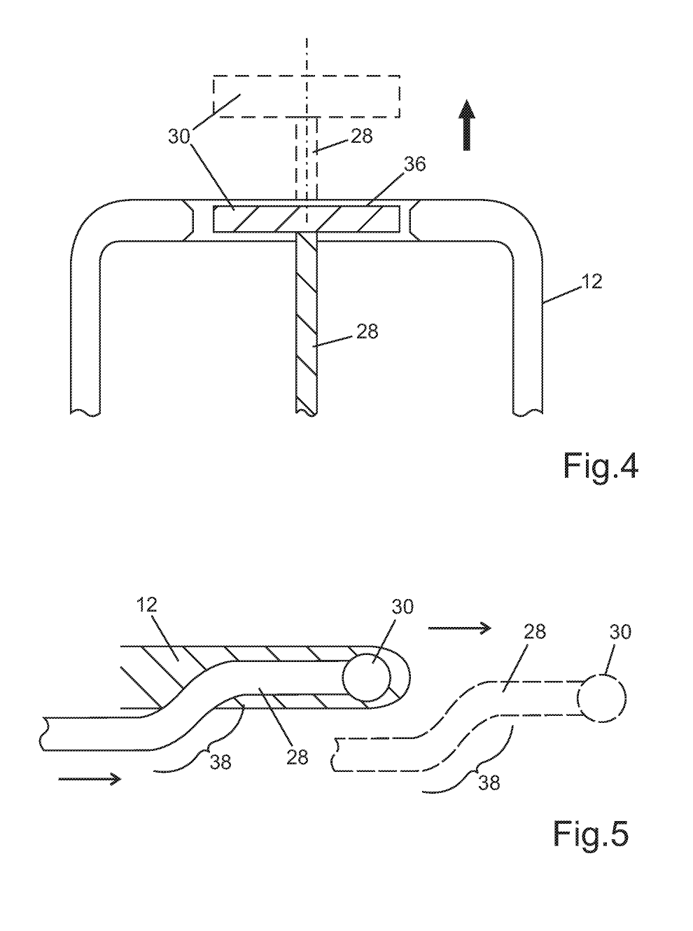

The drawbar 28 projects to an upper end of the base frame 12 in FIG. 1 and comprises a T-shaped grab handle 30, which is detachably countersunk in the upper region of the base frame 12. A detailed description of the grab handle 30 is seen below in the descriptions of FIGS. 4 and 5.

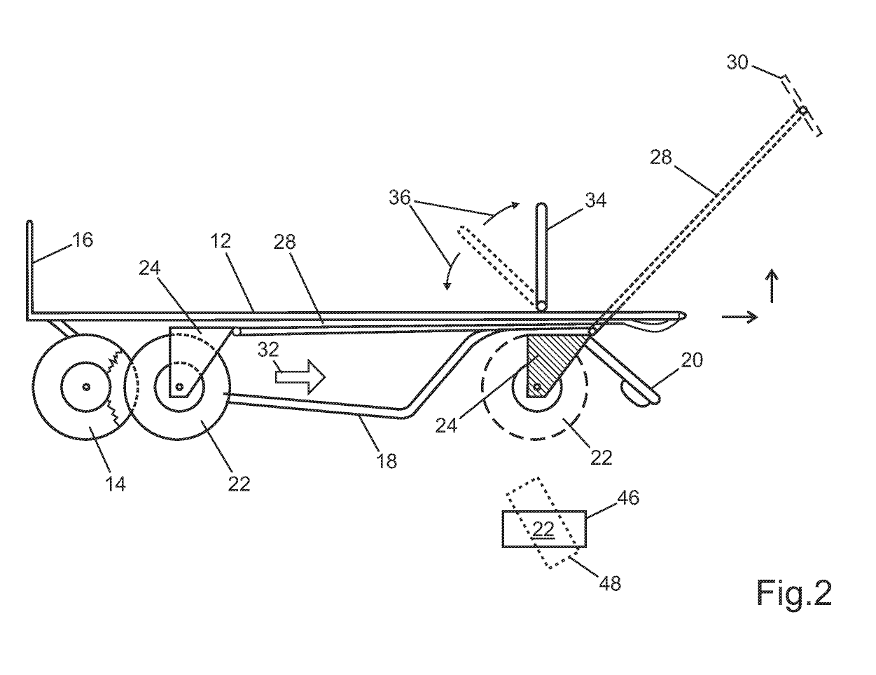

The embodiment of the transporting device 10 described in FIG. 1 allows the conversion of the uniaxial transporting device 10 that is used as a hand truck into a biaxial transport cart. FIG. 2 illustrates the conversion of the transporting device 10 from a hand truck into a transport cart. In this connection, the transporting device 10 in FIG. 2 is already shown in a position in which it can be operated as a transport cart, i.e. with two axles. This means that the transporting device 10, when operated as a transport cart, is tilted 90 degrees compared to the position in FIG. 1, so that all three wheels, 14, 22 come into contact with the floor. Then the support wheel 22 is pulled, in the guide rail 26, to the stop 27 in the second end position (to the right in FIG. 2).

The dotted line representation in FIG. 2 shows the state of the transporting device 10 after conversion. By guiding the support wheel in the guide rail 26, the support wheel 22 can be drawn by means of the shaft 28, from the region of the transport wheels 14 (first end position) to the region of the grab handle 20 (second end position) (cf. reference sign 32). The drawbar now protrudes from the frame 12 and can be used as a tow bar for the transport cart. The T-shaped grab handle 30 or the shaft 28 facilitates drawing the transport cart.

In order to make the transport cart steerable, the support wheel 22, in the region of the guide in the guide rail 26, includes a ball bearing (not visible in FIGS. 1 to 3), so that the support wheel 22 can be pivoted vertically to the frame by means of the shaft 28. A detailed explanation of this is seen below in the description of FIG. 6.

In order to secure the objects to be transported, a foldaway transport support 34 is countersunk in the frame 12. During operation of the transporting device 12 as a transport cart, said transport support can be folded parallel to the loading shovel 16 (cf. reference sign 36). FIG. 3 shows the transporting device 10 after conversion into a transport cart.

FIG. 4 shows the upper area of the frame 12 in FIG. 1, which is configured as a retaining bracket. The retaining bracket has a notch 36 that can accommodate the T-shaped grab handle 30 of the shaft 28 during operation of the transporting device 10 as a hand truck. In this position, the grab handle 30 is integrated into the frame 12.

In an embodiment of the transporting device 10 that is more convenient to use, in a region near the grab handle 30, the drawbar 28 is bent twice away from the bearing region of the transporting device 10 (cf. reference sign 38). This makes it easier to take the grab handle 30 out of the slot 36 in order to convert the transporting device 10. In addition, in this embodiment, the diameter of the grab handle 30 is somewhat thicker relative to the drawbar 28. In this way, a tractive force for drawing the transport cart is better distributed on the palm of the hand of the person pulling the transport cart, which facilities drawing the transport cart.

FIG. 6 shows the support wheel 22 with the device for moving the support wheel 22 in the guide rail 26 in detail. The support wheel 22 is guided and supported between the two metal plates 24, whereby the metal plates 24 are joined in a U-shaped manner toward the top by means of a connecting front side 40. The drawbar is attached to the front side 40 (not visible). A ball bearing 42 is arranged on the front side 40, which forms the connection between the support wheel 22 and a slot nut 44. The slot nut 44 slides in the C-shaped guide rail 26, the guide rail 26 being delimited on its two ends by stops (only the upper stop 27 is visible in FIG. 1). At the stops, the slot nut 44 can also snap into a recess provided in the guide rail 26 (not shown). The ball bearing 42 and the U-shaped metal plates 24, 40 form a center pivot plate for the support wheel 22.

The inventive transporting device 10 can be used as follows:

When using the transporting device 10 as a hand truck, the support wheel 22 is arranged near the transport wheels 14 at a first stop and serves, for example, as a support for drawing the hand truck up a flight of stairs. The drawbar 28 is situated in the middle of the frame 12; the grab handle 30 is countersunk in the recess 36 in the frame 12.

In order to convert the transporting device 10, the grab handle 30 is taken out of the recess 36, and the support wheel 22, which is firmly connected to the drawbar 28, is pushed into the opposite region 22 of the frame 12. This takes place when the slot nut 44, which is connected to the support wheel 22 by means of the ball bearing 42, slides in the guide rail 26 from the first stop (first end position) to the second stop (second end position. The transporting device 10 is tipped 90 degrees, so that the transport wheels 14 and the support wheel 22 come into contact with the floor, and a horizontal loading surface is accomplished. The drawbar 28 now protrudes beyond the frame 12 and serves as a tow bar for the hand truck that has been converted into a transport cart. In addition, the loading support 34 parallel to the tailboard 16 can be folded up. The ball bearing arranged between the support wheel 22 and the slot nut 44 supports the steering of the transport car by pivoting the tow bar. In a top view, the reference sign 46 in FIG. 2 shows the position of the support wheel 22 when moving straight ahead; the reference sign 48 shows a possible turn of the support wheel 22 by pivoting the drawbar 28 during a steering movement.

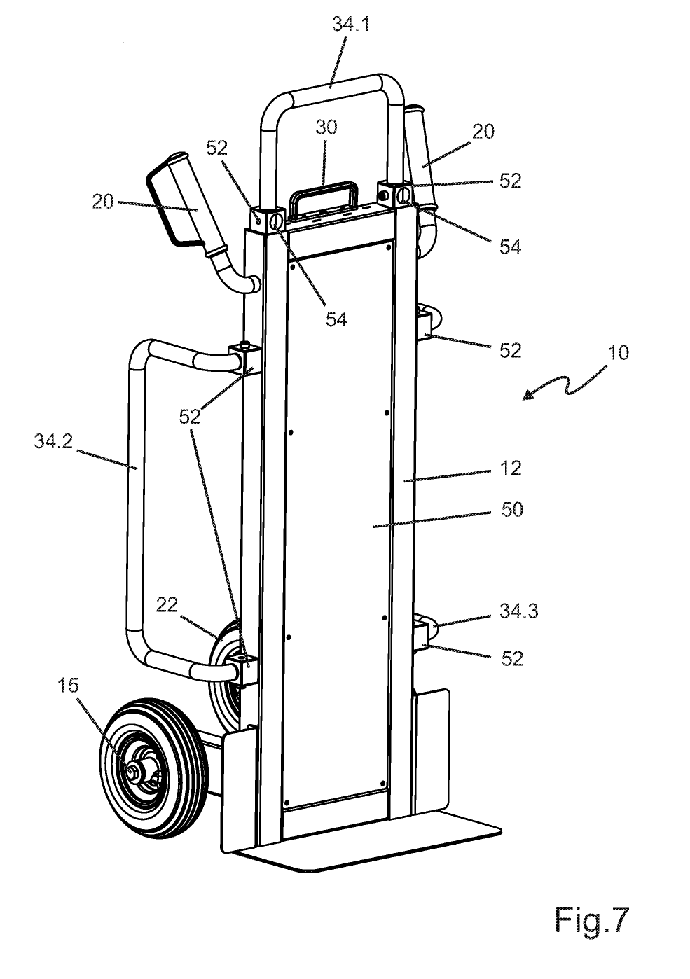

FIG. 7 shows an isometric representation of a second exemplary embodiment of an inventive transporting device 10. In connection with the second exemplary embodiment, the same reference signs are used as for the first exemplary embodiment (FIGS. 1-6), and the statements made concerning the first exemplary embodiment also apply in this case. In order to avoid repetitions, only the differences between the exemplary embodiments will be explained in more detail.

In the case of the second exemplary embodiment, the base frame 12 is configured as a sheet metal construction. The base frame 12 is produced by bending sheet metal, preferably steel or aluminum, and subsequently welding the pieces together. The structure and the configuration of the base frame 12 can be seen particularly well in FIG. 14.

The base frame 12 is covered by a plate 50 that serves as a loading surface. Correspondingly, the plate, if mainly fragile goods are transported, can consist of a wood or panel material coated with rubber or a soft plastic. If non-fragile and very heavy loads are to be transported, the plate 50 can be made of steel plate, preferably of so-called raised-pattern plate.

Square cut-shaped fastening elements are provided on the longitudinal sides and the front side of the base frame shown in FIG. 7. The fastening elements 52 are firmly attached to the base frame 12. Among other things, it is possible to screw or weld the fastening elements 52 to the base frame 12. The fastening elements 52 have at least one, but preferably two receiving bores 54 that are arranged orthogonally to one another. The receiving bores serve to mount the transport supports 34, which in the second exemplary embodiment are designed as tube sections bent into a U-shape.

In FIG. 7, three transport supports 34.1, 34.2, and 34.3 are shown. In this case, the transport support 34.1 is inserted into the fastening elements 52 in such a way, and fixed there by means of a locking screw (without reference sign), that the transport support 34.1 is parallel to the plate 50 and does not protrude from it at the top. In addition, the laterally arranged transport supports 34.2 and 34.3 are also inserted this way into the corresponding fastening elements 52 and are also fixed in place there with an attachment screw, so that they do not protrude from the top of the plate 50.

In the installation position shown in FIG. 7, the laterally arranged transport supports 34.2 and 34.3 takes over the function of the support device 18 according to the first exemplary embodiment (see, for example, FIGS. 1 and 3). In order to take over this function, the transport supports 34.2 and 34.3 are configured as a U-shaped tube section that is bent once again at a right angle in the region of the fastening elements 52.

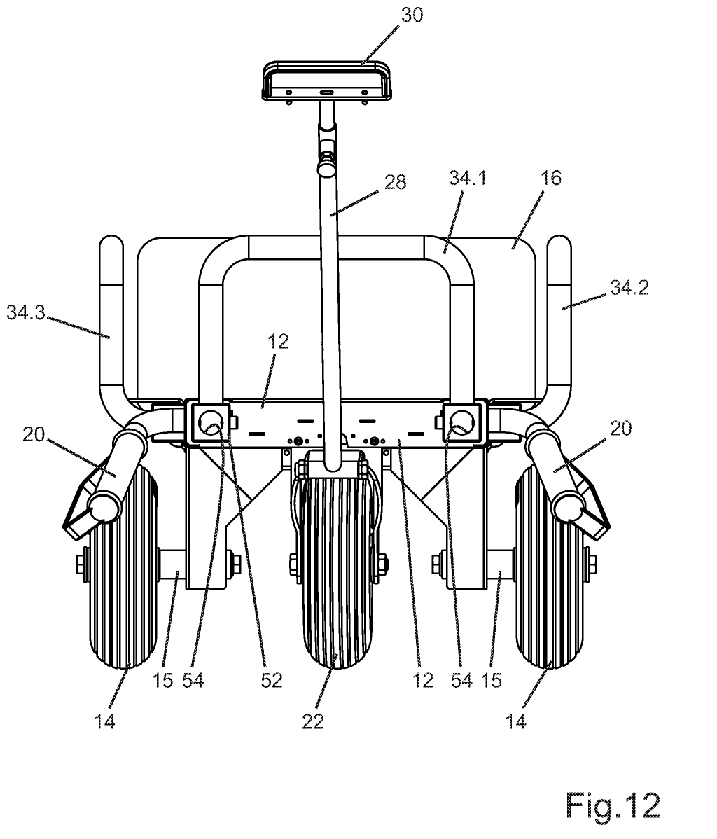

At the upper end of the base frame 12, the two receiving bores 54 are easily visible in the fastening elements 52. The transport support 34.1 can also be inserted into these second receiving bores 54 (see FIG. 11). This takes place when the inventive transporting device 10 is to be used as a transport cart. Then the transport support 34.1 has the function of the transport support 34 shown in FIG. 3. Correspondingly, it is also possible to insert the transport supports 34.2 and 34.3 inversely into the fastening elements 52, so that they serve as a lateral wall of the transporting device (see also FIGS. 11 and 12).

In summary, the laterally arranged transport supports 34.2 and 34.3, in the position shown in FIG. 7, take over the function of the support device 18 and, in the position shown in the FIGS. 11 and 12, can serve as a lateral wall of the inventive transporting device 10.

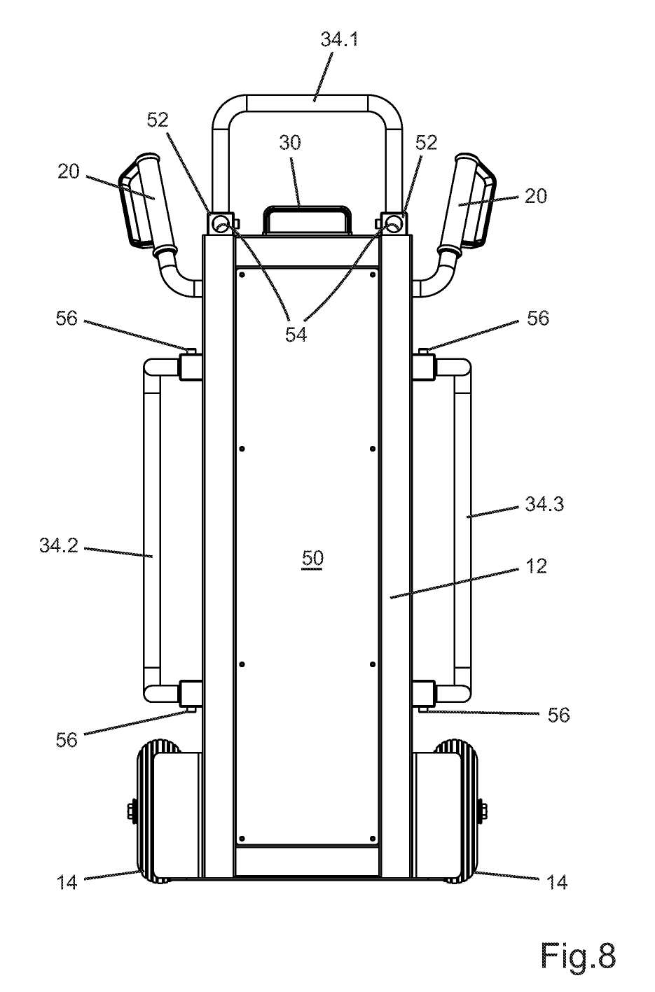

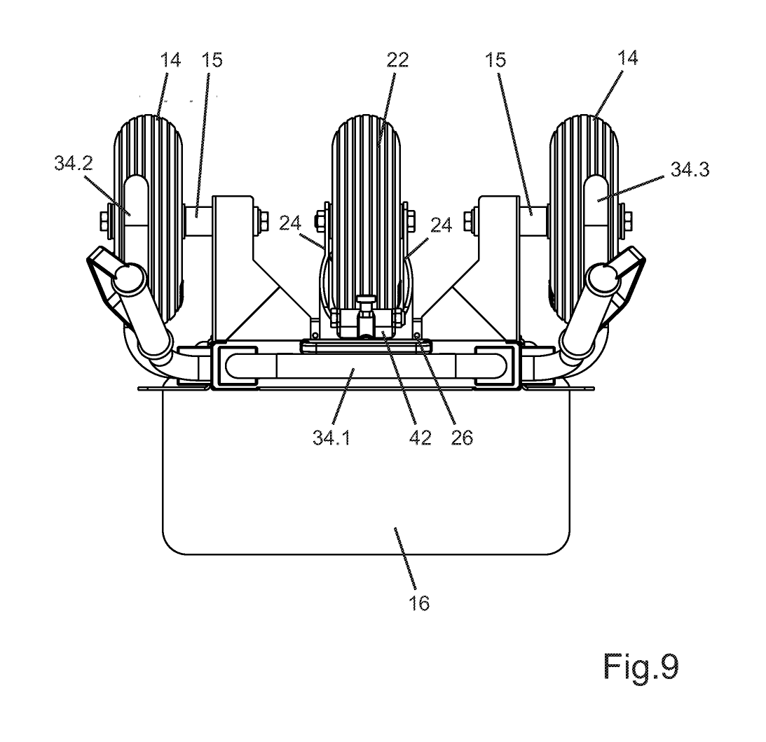

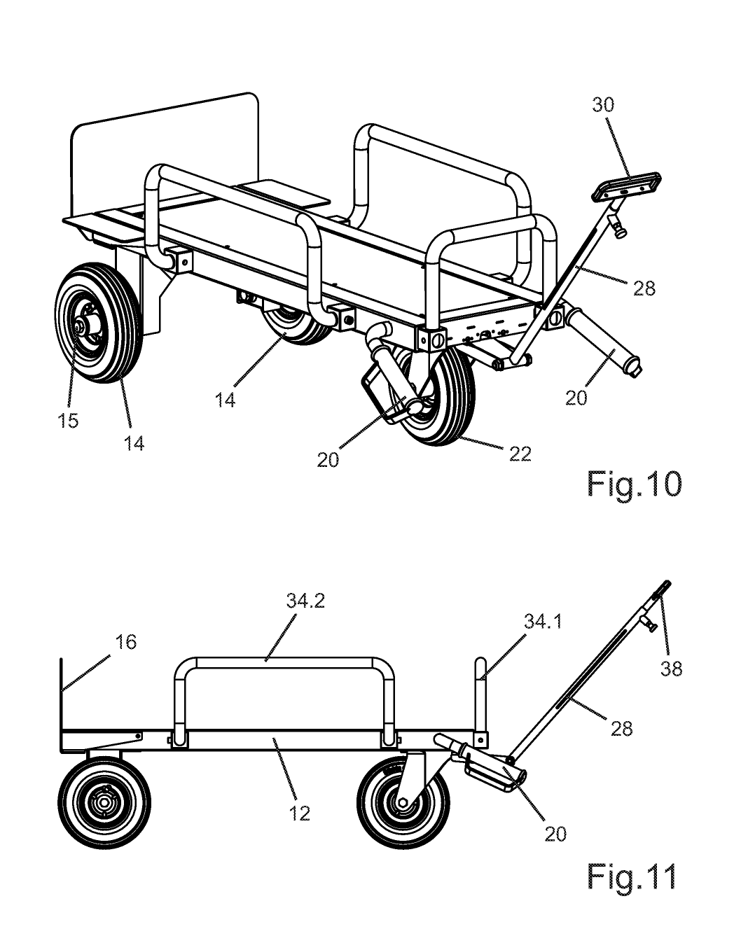

In the exemplary embodiment according to FIG. 7, the grab handle is designed as a closed bracket. In FIGS. 8, 9, and 10, the second exemplary embodiment is shown in a front view (FIG. 8), in a lateral view (FIG. 9), and top in a view (FIG. 10). The geometry and arrangement of the transport supports 34.1, 34.2 and 34.3, as well as the fastening elements 52, are apparent from these views. In FIG. 9, it can be seen particularly well that the lateral transport supports 34.2 and 34.3 can take over the function of the support device 18 in a downward direction. The attachment screws 56 of the fastening elements 52 can be seen well in FIG. 8.

In FIGS. 11 and 12, the second exemplary embodiment of the inventive transporting device 10 has been converted into a transport cart. This takes place by pulling the drawbar 28 out of the base frame 12, and as a result of that, the support wheel 22 is moved to the end of the base frame 12 opposite the transport wheels 14. The drawbar 28 is shown as if lying in the hand of a user of the transporting device who is not shown.

In FIGS. 11-13, the transport supports 34.1, 34.2 and 34.3 are mounted in such a way that, together with the loading shovel 16, they form four lateral walls of a transport cart.

Of course it is also possible, for example, to place only the transport support 34.1 into the position shown in FIGS. 11-13 and leave the transport supports 34.2 and 34.3 in the position in which they are shown in FIGS. 7-10.

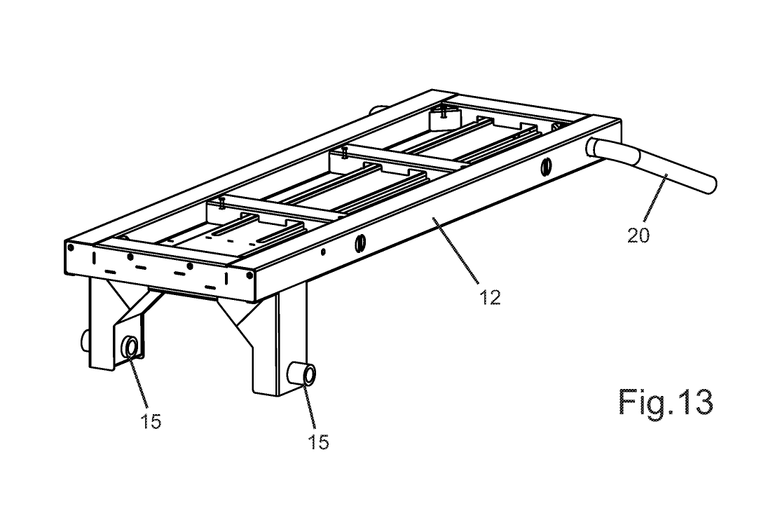

From a comparison of the FIGS. 7 to 10 and 11 to 13, only a few adjustments are required to transform a fully functional hand truck into an equally fully functional transport cart with four lateral walls. The construction of the base frame with sheet metal additionally improves the load-bearing capacity, so that loads weighing several hundred kilograms can be securely transported with the transport cart. Correspondingly, the mounting of the shaft 15 (see FIG. 13) is also able to carry extreme loads due to the large, load-bearing cross-sections.

FIG. 14 is an isometric representation of the base frame 12 without installed components. In this representation, the structure of the base frame 12 consisting of folded metal plates are welded together is apparent. The extremely robust mounting of the shafts 15 can also be easily recognized.

What is claimed is:

1. A transporting device for transporting loads by hand with a base frame having two transport wheels at a lower end opposite a loading shovel, characterized in that a support wheel is arranged in the center between the transport wheels, and that said support wheel can be arranged on an end of the base frame opposite the transport wheels.

2. The transporting device according to claim 1, characterized in that the support wheel is displaceable in a longitudinal direction of the base frame between a first end position and a second end position.

3. A transporting device according to claim 1, characterized in that the support wheel is connected to a drawbar.

4. The transporting device according to claim 3, characterized in that the drawbar can be used as a drawing and steering rod for the transporting device.

5. A transporting device according to claim 1, characterized in that in the first end position of the support wheel, a grab handle of the tow bar is countersunk in a retaining bracket of the base frame, said retaining bracket being arranged opposite the transport wheels.

6. A transporting device according to claim 1, characterized in that the support wheel includes means with which the support wheel can be displaced in a guide rail in the center of the longitudinal extension of the base frame.

7. The transporting device according to claim 6, characterized in that the first end position and the second end position of the support wheel are characterized by stops in the guide rail.

8. A transporting device according to claim 1, characterized in that the support wheel can be guided into the second end position.

9. A transporting device according to claim 1, characterized in that, in a first end position of the support wheel, the transporting device can be used as a hand truck, and in the second end position of the support wheel as a transport cart.

10. A transporting device according to claim 1, characterized in that at least one loading support is provided on the base frame.

11. The transporting device according to claim 10, characterized in that the loading supports can be mounted in at least two different positions.

12. The transporting device according to claim 10, characterized in that at least one loading support can be folded together.

13. A transporting device according to claim 1, characterized in that the base frame essentially consists of metal tubes.

14. A transporting device according to claim 1, characterized in that the base frame is comprised essentially of sheet metal, in particular folded sheet metal.
